(19) United States
(12) Patent Application Publication
(10) Pub. No.: US 2011/0148805 A1
(43) Pub. Date: Jun. 23, 2011

(54) POINTING DEVICE

(76) Inventor: Tsung-Ting LEE, Chiayi County (TW)

(21) Appl. No.: 12/786,836

(22) Filed: May 25, 2010

(30) Foreign Application Priority Data
Dec. 21, 2009 (TW) 098143955

(51) Int. Cl. G06F 3/033

(52) U.S. Cl. 345/174; 340/407.2

(57) ABSTRACT

A pointing device includes a covering material and a touch sensing unit. The covering material is at least made of a flexible material. The touch sensing unit is buried in the covering material and has two touch sensing surfaces. The pointing device contains the touch control feature, so that it is not necessary to provide a plane of a certain area for operating the pointing device, so as to improve the application convenience thereof.

### CROSS REFERENCE TO RELATED APPLICATIONS

This Non-provisional application claims priority under 35 U.S.C. §119(a) on Patent Application No(s). 098143955 filed in Taiwan, Republic of China on Dec. 21, 2009, the entire contents of which are hereby incorporated by reference.

### BACKGROUND OF THE INVENTION

1. Field of Invention

The invention relates to a pointing device.

2. Related Art

In the information era, computers have become indispensible articles for daily use. In practice, the keyboard and mouse are commonly used to serve as the human-machine interfaces for communicating the user and computer.

The present mouse includes a sensor disposed at the bottom side of the mouse, so that when the user slides the mouse on a plane, the cursor displayed on the screen can be moved correspondingly. Accordingly, the user can control the movement of the cursor by moving the mouse, for example, to point an icon, and click the button of the mouse to execute one of various programs of the computer corresponding to the icon.

However, the user needs to hold the mouse and slide it on a plane to make the sensor at the bottom side of the mouse sense the sliding direction and distance so that the cursor on the screen can move correspondingly. So, when the user operates the mouse, a plane of a certain area is necessary for allowing the mouse to slide thereon, which may cause restriction on usage.

On the other hand, the touch control feature is easier for operation and more intuitive for users. Besides, with the progress of touch technology, more and more electronic apparatuses are equipped with touch control interface as the human-machine interface.

### SUMMARY OF THE INVENTION

In view of the foregoing, an object of the invention is to provide a pointing device that contains touch control feature, so that it is not necessary to provide a plane of a certain area for operating the pointing device, so as to improve the application convenience thereof.

To achieve the above object, a pointing device according to the invention includes a covering material and a touch sensing unit. The covering material is at least made of a flexible material. The touch sensing unit is buried in the covering material and has two touch sensing surfaces.

In an aspect of the invention, the covering material is sealed.

In an aspect of the invention, the touch sensing unit is of a capacitance type or a resistive type.

In an aspect of the invention, the touch sensing surfaces are located at different planes.

In an aspect of the invention, the pointing device further comprises a feedback unit. When the covering material is touched or pressed to enable the touch sensing unit to generate a touch sensing signal, the feedback unit generates a feedback signal.

In an aspect of the invention, the pointing device further comprises a proximity sensing unit disposed between the touch sensing surfaces. When the covering material is pressed to change the interval between the touch sensing surfaces, the proximity sensing unit correspondingly generates a sensing signal.

As mentioned above, in the pointing device of the invention, the covering material covers the touch sensing unit and is at least made of a flexible material, and the touch sensing unit is buried in the covering material and has two touch sensing surfaces. Thus, the user can hold the pointing device and touch or press it to execute functions of, for example, moving the cursor, clicking the button, dragging the page, turning the page, etc. Therefore, the user just holds the pointing device to operate it. In other words, the pointing device can control the movement of the cursor without the operation of sliding on a plane of a certain area, so that the user can use the pointing device more conveniently. In addition, in some embodiments, the touch sensing surfaces of the pointing device are configured to enable different functions. For example, one of the touch sensing surfaces can enable the function of clicking button, and the other can enable the functions of moving the cursor, dragging, and turning the page. Hence, the pointing device of the invention can make more fun for usage.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic view of a pointing device according to a preferred embodiment of the invention, and FIG. 1B is a schematic view showing an enlargement of a portion of the pointing device;

FIGS. 2A and 2B are schematic views of the touch sensing circuit of the pointing device of the preferred embodiment of the invention;

FIG. 3 is a schematic diagram showing the situation of using the pointing device of the preferred embodiment of the invention; and

FIGS. 4 to 6 are schematic diagrams of the pointing devices of various aspects according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

### First Embodiment

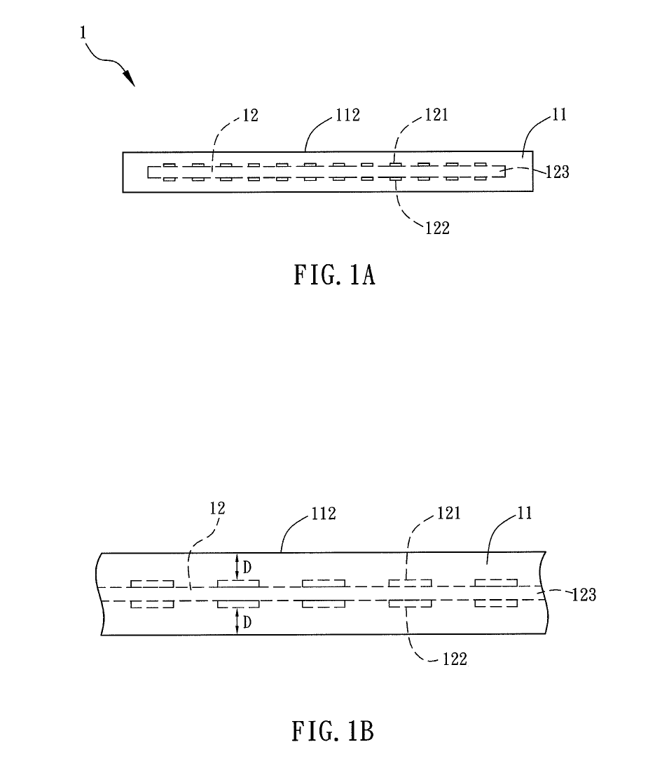

FIG. 1A is a schematic view of a pointing device 1 according to a preferred embodiment of the invention, and FIG. 1B is a schematic view showing an enlargement of a portion of the pointing device 1. In the embodiment, the pointing device 1 means the device serving as a human-machine interface, and for example, it can replace the mouse. The pointing device 1 includes a covering material 11 and a touch sensing unit 12.

The covering material 11 is at least made of a flexible material. The covering material 11 of the embodiment is shaped like a plate for example, and it can be bent to any desired angle. Otherwise, the covering material 11 can be made like other shapes.

The touch sensing unit 12 is buried in the covering material 11 and has two touch sensing surfaces 121 and 122. The touch sensing unit 12 can also be made of a flexible material. In this embodiment, the covering material 11 is sealed. The covering material 11 can be combined with the touch sensing unit 12 by injection molding or insert molding, so that the covering material 11 can tightly cover the touch sensing unit 12. That is, the covering material 11 can directly contact the touch sensing surfaces 121 and 122. The distance D from the exterior surface 112 of the covering material 11 to the touch sensing surfaces 121 or 122 can be smaller than 5 mm. Because the covering material 11 is very thin, the operation of the touch sensing surfaces 121 and 122 will not be hindered. Otherwise, the covering material 11 and the touch sensing unit 12 can be separately manufactured and then assembled with each other. In another aspect, the covering material 11 can be unsealed. The touch sensing unit 12 of this embodiment can be of a capacitance type or a resistive type.

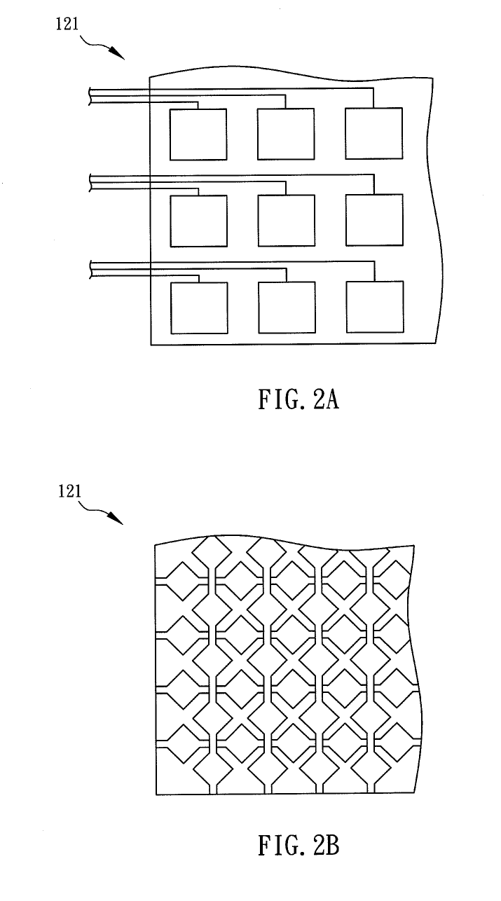

The touch sensing unit 12 can further include a flexible circuit board 123, and the touch sensing surfaces 121 and 122 are disposed at two opposite sides of the flexible circuit board 123 respectively. To be noted, the touch sensing unit 12 can have a plurality of flexible circuit boards 123, and the touch sensing surfaces 121 and 122 are disposed on the flexible circuit boards 123 respectively. Each of the touch sensing surfaces 121 and 122 can have at least a touch sensing circuit, and the touch sensing circuit can be, for example, a single-layer circuit (see FIG. 2A) or a double-layer circuit. Besides, the touch sensing circuit can also be a matrix double-layer circuit (see FIG. 2B).

When the covering material 11 is touched or pressed, the touch sensing unit 12 can correspondingly generate a touch signal, which can be transmitted through a wired transmission or a wireless transmission. Here the touch signal is transmitted through a wireless transmission for example. Otherwise, the pointing device 1 can transmit the touch signal through a wire (not shown).

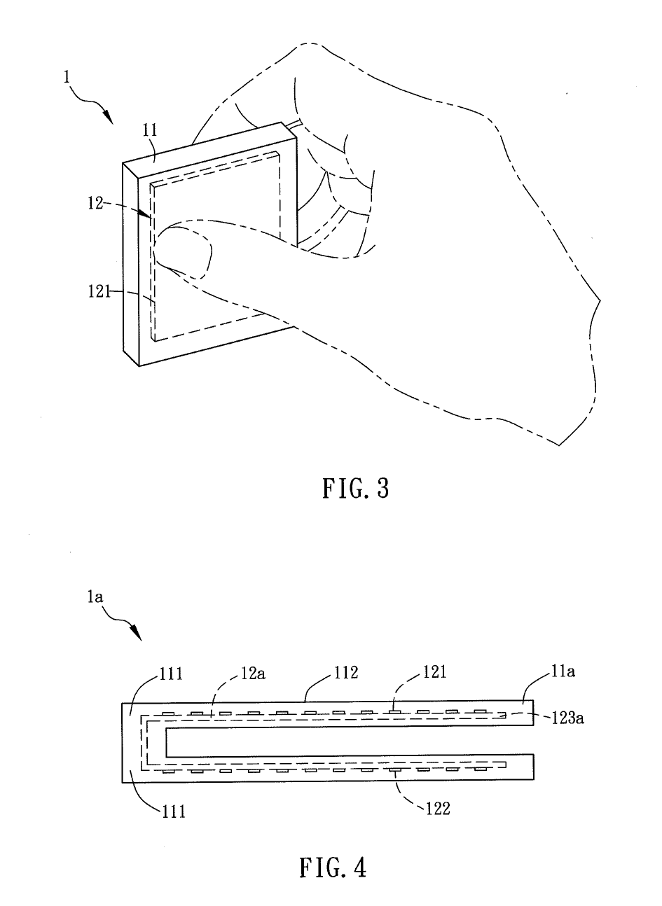

Accordingly, as shown in FIGS. 1A and 3, when the user holds the pointing device 1 (for example, the thumb of the user is located at the side of the touch sensing surface 121, and the other fingers are located at the side of the touch sensing surface 122), the user can control the thumb to touch or press the touch sensing surface 121. Then, the touch sensing surface 121 senses the clicking and moving of the thumb and thus the cursor displayed on the screen can move correspondingly, so that the computer can execute the function through the operation of the user. As for the touch sensing surface 122, it can sense the clicking and moving of the fingers as the same way of the touch sensing surface 121 when the user touches or presses the touch sensing surface 122 with the finger(s). Therefore, during the operation of the pointing device 1, the user just holds it. In other words, the pointing device 1 can control the movement of the cursor without the operation of sliding on a plane of a certain area, so that the usage of the pointing device 1 can be more convenient.

Furthermore, the touch sensing surfaces 121 and 122 can be defined to enable different functions. For example, the touch sensing surface 121 operated by the thumb can be defined to enable the movement of the cursor; the touch sensing surface 122 operated by the other fingers can be defined to enable the clicking of the button (when the finger clicks or presses it), the dragging or turning of the page (when the finger slides). To be noted, the functions of the touch sensing surfaces 121 and 122 can be changed. For example, the touch sensing surface 121 may control the function of clicking the button, dragging the page or turning the page, and the touch sensing surface 122 may control the function of moving the cursor. Besides, the functions corresponding to the touch sensing surfaces 121 and 122 can be preset in the pointing device 1, or updated or changed through the firmware.

Besides, the pointing device 1 can further include a feedback unit (not shown). When the covering material 11 is touched or pressed to enable the touch sensing unit 12 to generate a touch sensing signal, the feedback unit generates a feedback signal. The feedback signal can be an optic feedback signal (e.g. the variation of the brightness or color displayed by the pointing device 1), a vibrational feedback signal (e.g. the vibration generated at the pressed location or that generated on the pointing device 1), or an acoustic feedback signal (e.g. the various sounds outputted by the pointing device 1 or the sound device of the computer to indicate the operation of clicking or sliding by the user).

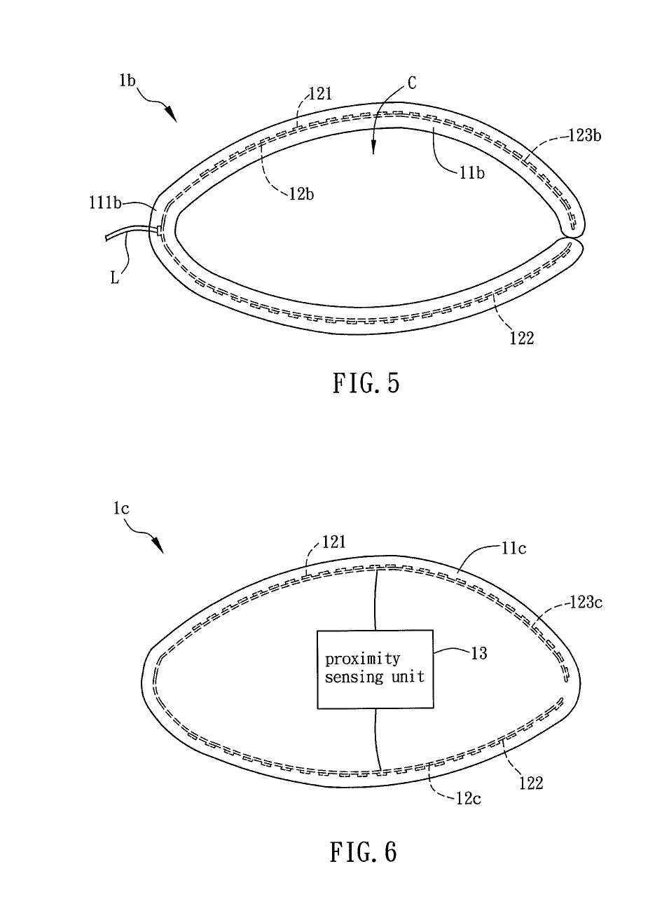

FIG. 4 is a schematic diagram of the pointing device 1a of another aspect. As shown in FIG. 4, the covering material 11a of the pointing device 1a can have at least a bending portion 111. In the embodiment, the covering material 11a is illustrated to have two bending portions 111, and thus the cross-section of the pointing device 1a in FIG. 4 is similar to U shape. Of course, the cross-section of the pointing device 1a can have different shapes.

Because the flexible circuit board 123a is flexible, the touch sensing surfaces 121 and 122 can be disposed at two opposite sides of the pointing device 1a, and that is, the touch sensing surfaces 121 and 122 are disposed at different planes. Besides, the touch sensing circuit is usually not disposed at the bending portions 111 that connect the planes, so that the touch sensing circuit just exists at an upper side and a lower side of the flexible circuit board 123a. Otherwise, the touch sensing surfaces 121 and 122 can be disposed on different flexible circuit boards or inflexible printed circuit boards (PCB). In this case, the touch sensing surfaces 121 and 122 can be connected with each other by an electric connection element.

FIG. 5 is a schematic diagram of the pointing device 1b of another aspect. As shown in FIG. 5, the covering material 11b of the pointing device 1b has a single bending portion 111b, and thus the cross-section of the pointing device 1b is similar to C shape. Similarly, the touch sensing unit 12b is buried in the covering material 11b, and the covering material 11b forms a chamber C. Besides, the pointing device 1b here can transmit the touch signal through a wire L. To be noted, those skilled in the art can design various different structures according to the above-mentioned pointing devices 1a and 1b.

FIG. 6 is a schematic diagram of the pointing device 1c of another aspect. As shown in FIG. 6, the covering material 11c of the pointing device 1c is solid and the touch sensing unit 12c is also buried in the covering material 11c. Besides, the pointing device 1c can further include a proximity sensing unit 13 which is disposed between the touch sensing surfaces 121 and 122. That means, the proximity sensing unit 13 can be disposed on one surface of the flexible circuit board 123c away from the touch sensing surfaces 121 and 122, or disposed inside the covering material 11c and located between the touch sensing surfaces 121 and 122. The proximity sensing unit 13 can be of a capacitance type or an inductive type.

Thus, when the covering material 11c is pressed by the finger or the palm of the user to change the interval between the touch sensing surfaces 121 and 122, the proximity sensing unit 13 correspondingly generates a sensing signal which can be transmitted through a wired transmission or a wireless transmission. Accordingly, the user can operate the pointing device 1c through the action of pressing. Therefore, the functions of the pointing device 1c can be increased and the user can have more operation methods.

In summary, in the pointing device of the invention, the covering material covers the touch sensing unit and is at least made of a flexible material, and the touch sensing unit is buried in the covering material and has two touch sensing surfaces. Thus, the user can hold the pointing device and touch or press it to execute functions of, for example, moving the cursor, clicking the button, dragging the page, turning the page, etc. Therefore, the user just holds the pointing device to operate it. In other words, the pointing device can control the movement of the cursor without the operation of sliding on a plane of a certain area, so that the user can use the pointing device more conveniently. In addition, in some embodiments, the touch sensing surfaces of the pointing device are configured to enable different functions. For example, one of the touch sensing surfaces can enable the function of clicking button, and the other can enable the functions of moving the cursor, dragging, and turning the page. Hence, the pointing device of the invention can make more fun for usage.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A pointing device, comprising:
a covering material at least made of a flexible material; and
a touch sensing unit buried in the covering material and having two touch sensing surfaces.

2. The pointing device as recited in claim 1, wherein the covering material is sealed.

3. The pointing device as recited in claim 1, wherein the touch sensing unit is of a capacitance type or a resistive type.

4. The pointing device as recited in claim 1, wherein the touch sensing surfaces are located at different planes.

5. The pointing device as recited in claim 1, wherein the touch sensing surfaces are located at two opposite sides of the covering material respectively.

6. The pointing device as recited in claim 1, wherein the covering material forms a chamber.

7. The pointing device as recited in claim 1, wherein the covering material has at least one bending portion.

8. The pointing device as recited in claim 1, wherein the covering material contacts the touch sensing surfaces directly.

9. The pointing device as recited in claim 8, wherein the distance from the exterior surface of the covering material to the touch sensing surface is smaller than 5 mm.

10. The pointing device as recited in claim 1, wherein when the covering material is touched or pressed, the touch sensing unit correspondingly generates a touch sensing signal.

11. The pointing device as recited in claim 10, wherein the touch sensing signal is transmitted through a wired transmission or a wireless transmission.

12. The pointing device as recited in claim 10, wherein the touch sensing surfaces sense a clicking and a movement motion respectively.

13. The pointing device as recited in claim 1, wherein the touch sensing unit further has a flexible circuit board, and the touch sensing surfaces are disposed on the flexible circuit board.

14. The pointing device as recited in claim 1, wherein each of the touch sensing surfaces has at least one touch sensing circuit, and the touch sensing circuit is a single-layer circuit or a double-layer circuit.

15. The pointing device as recited in claim 14, wherein the touch sensing circuit is a matrix double-layer circuit.

16. The pointing device as recited in claim 1, further comprising:
a feedback unit, wherein when the covering material is touched or pressed to enable the touch sensing unit to generate a touch sensing signal, the feedback unit generates a feedback signal.

17. The pointing device as recited in claim 16, wherein the feedback signal is an optic feedback signal, a vibrational feedback signal, or an acoustic feedback signal.

18. The pointing device as recited in claim 1, further comprising:
a proximity sensing unit disposed between the touch sensing surfaces, wherein when the covering material is pressed to change the interval between the touch sensing surfaces, the proximity sensing unit correspondingly generates a sensing signal.

19. The pointing device as recited in claim 18, wherein the proximity sensing unit is of a capacitance type or an inductive type.

20. The pointing device as recited in claim 18, wherein the sensing signal is transmitted through a wired transmission or a wireless transmission.
